(19) United States
(12) Patent Application Publication
(10) Pub. No.: US 2023/0415205 A1
(43) Pub. Date: Dec. 28, 2023

(54) MOTOR DISPOSED BELOW PRESSURE PUMP

(71) Applicant: Honda Motor Co., Ltd., Tokyo (JP)

(72) Inventor: Kota TOKUBI, Saitama (JP)

(73) Assignee: Honda Motor Co., Ltd., Tokyo (JP)

(21) Appl. No.: 17/848,394

(22) Filed: Jun. 24, 2022

(51) Int. Cl. B08B 3/02; B08B 13/00

(52) U.S. Cl. CPC B08B 3/026; B08B 13/00; B08B 2203/0223; B08B 2203/027

(57) ABSTRACT

A washing device includes a motor having a shaft, a battery electrically connected to the motor, and a pump driven by the motor. The pump is adapted to pressurize a liquid. The pump is disposed on the motor so that the motor is disposed between the pump and a ground.

### BACKGROUND

### Technical Field

The disclosure relates to a washing device and more specifically relates to a mounting configuration of a motor of the washing device.

### Description of Related Art

In Patent Literature 1, a high pressure washing device includes a water pump mounted to a side of a motor. The present disclosure provides a mounting configuration of a motor of a washing device.

Patent literature 1: Japanese Patent Laid-Open No. 2015-000362

### SUMMARY

According to an embodiment of the disclosure, a washing device includes a motor having a shaft, a battery electrically connected to the motor, and a pump driven by the motor. The pump is adapted to pressurize a liquid. The pump is disposed on the motor so that the motor is disposed between the pump and a ground.

### BRIEF DESCRIPTION OF THE DRAWINGS

FIG. 1 is a schematic diagram illustrating a perspective view of a washing device according to an embodiment of the disclosure.

FIG. 2 is a schematic diagram illustrating a front view of the washing device of FIG. 1.

FIG. 3 is a schematic diagram illustrating a side view of the washing device of FIG. 1.

FIG. 4 is a schematic diagram illustrating a battery casing and a battery of the washing device according to an embodiment of the disclosure.

### DESCRIPTION OF THE EMBODIMENTS

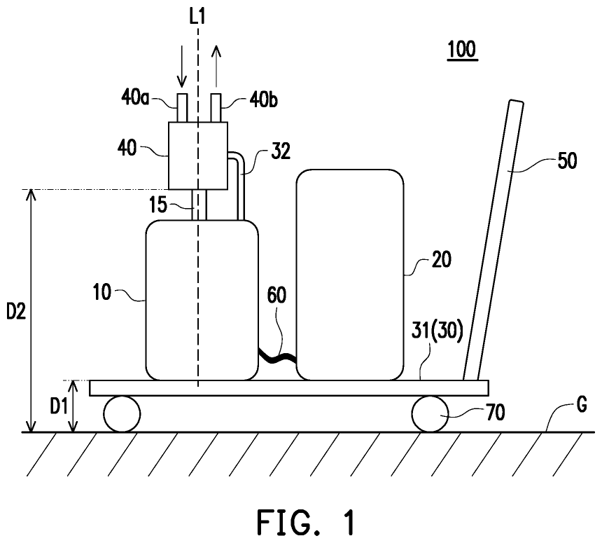

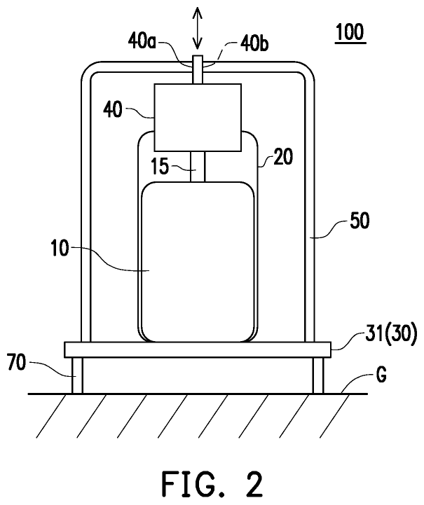

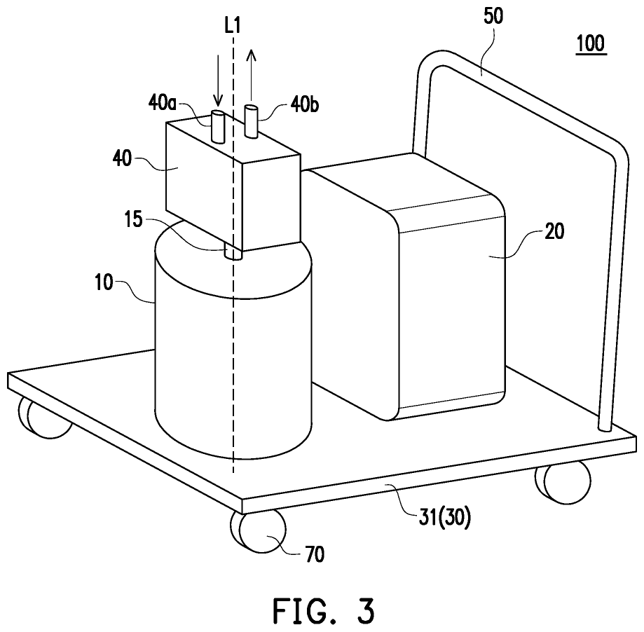

FIG. 1 is a schematic diagram illustrating a perspective view of a washing device according to an embodiment of the disclosure. FIG. 2 is a schematic diagram illustrating a front view of the washing device of FIG. 1. FIG. 3 is a schematic diagram illustrating a side view of the washing device of FIG. 1. Referring to FIG. 1 through FIG. 3, a washing device 100 is provided. The washing device 100 may be, for example, a high pressure washer. In the present embodiment, the washing device 100 includes a motor 10, a battery 20, a frame 30, and a pump 40.

The frame 30 may include a base 31. The base 31 may be, for example, a rigid substrate. A material of the base 31 may be, for example, metal, steel, aluminum, plastic, composite material and the like. In the present embodiment, the base 31 is a substantially rectangular shaped plate. However, the disclosure is not limited thereto. A shape of the base 31 is not intended to limit the disclosure and may be set according to requirements. In another embodiment of the disclosure, the base 31 may be omitted from the washing device 100.

The motor 10 is an electric motor powered by electricity. That is to say, the motor 10 is not powered by gas, and there is no gas tank connected to the motor 10. The motor 10 may be, for example, a brushless DC motor. In more detail, the motor 10 may be, for example, a 3 phase brushless DC motor. The motor 10 has a shaft 15 rotated by the motor 10. An axial direction of the shaft 15 extends parallel to an axial direction of the motor 10. In the present embodiment, the motor 10 is disposed on the base 31. The motor 10 may be fixed to the base 31 by, for example, a fastener to secure the motor 10 to the base 31. However, the disclosure is not limited thereto. In another embodiment of the disclosure, the base 31 may be omitted and the motor 10 may be disposed on a ground G.

The battery 20 may be, for example, a portable, swappable battery that stores electricity generated by renewable energy. In the present embodiment, the battery 20 is a rechargeable battery. The battery 20 may be recharged with renewable energy. The battery 20, for example, includes a plurality of battery cells inside the battery 20. The battery 20 may be detachably attached to the base 31. When the battery 20 is detachably attached to the base 31, a new battery 20 may be simply swapped such that supplying a power source to the motor 10 becomes easy. In the present embodiment, the battery 20 is disposed on the base 31 of the frame 30. The battery 20 may be fixed to the base 31 by, for example, a fastener to secure the battery 20 to the base 31. However, the disclosure is not limited thereto. In another embodiment of the disclosure, the base 31 may be omitted and the battery 20 may be disposed on the ground G. The battery 20 may be a lithium-ion battery. In the present embodiment, the battery 20 weighs, for example, approximately 10 kilograms.

The battery 20 is electrically connected to the motor 10. In the present embodiment, a wire 60 electrically connects the battery 20 to the motor 10. In this way, the motor 10 is powered by the battery 20 through the wire 60. The wire 60 may be, for example, a power cable wherein one end of the power cable is coupled to a positive terminal and a negative terminal of the battery 20, while another end of the power cable is coupled to the motor 10. When the battery 20 and motor 10 are electrically connected by the wire 60, electrical power may be supplied to the motor 10 even when the battery 20 is disposed at different locations of the washing device 100 or when the battery 20 is provided on the ground G instead of on the base 31. However, in another embodiment of the disclosure, the battery 20 may be electrically connected to the motor 10 by, for example, a terminal and the like without the wire 60.

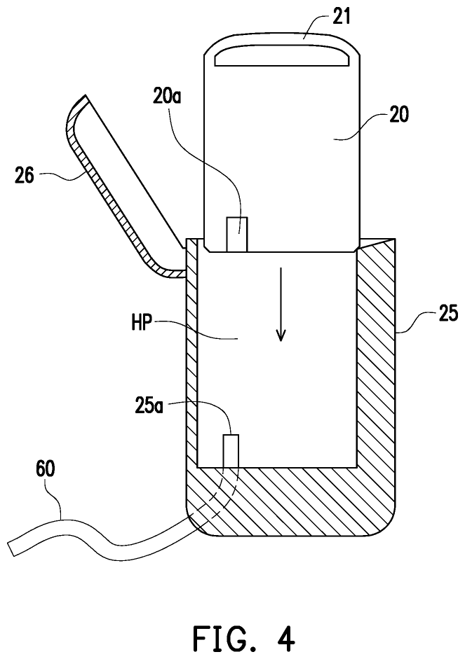

FIG. 4 is a schematic diagram illustrating a battery casing and a battery of the washing device according to an embodiment of the disclosure. Referring to FIG. 4, the washing device 100 includes a casing 25 for housing the battery 20. The casing 25 may be disposed on the base 31 of the washing device 100. The casing 25 may be fixed to the base 31. In another embodiment, the casing 25 may be disposed on the ground G instead of the base 31. The casing 25 may be hollow such that the battery 20 may be inserted into a hollow portion HP of the casing 25 and the battery 20 may be removed from the casing 25 when swapping or removing the battery 20. That is to say, the battery 20 is configured to be accommodated inside the hollow portion HP of the casing 25. The battery 20 includes a handle 21 for easy swapping of the battery 20. In an embodiment of the disclosure, the hollow portion HP of the casing 25 may have a substantially similar shape as an outer casing of the battery 20 so as to better house the battery 20.

The casing 25 includes a first connection terminal 25a. More specifically, the first connection terminal 25a is disposed at the bottom of the hollow portion HP of the casing 25. The first connection terminal 25a is disposed at the bottom of the casing 25 to face toward an opening of the casing 25. The battery 20 is configured to be inserted through the opening of the casing 25. The first connection terminal 25a of the casing 25 is electrically connected to the one end of the wire 60. In addition, the casing 25 includes a cover 26 which is pivoted on a hinge (not shown), wherein the cover 26 may be opened or closed about the hinge to prevent dust or particles to enter the hollow portion HP of the casing 25.

The battery 20 includes a second connection terminal 20a on a bottom surface of the battery 20. The second connection terminal 20a is electrically connected to the battery 20. The casing 25 and the battery 20 are configured such that, when the battery 20 is inserted into the hollow portion HP of the casing 25, the first connection terminal 25a of the casing 25 physically engages with the second connection terminal 20a of the battery 20, such that the motor 10 may be electrically powered by the battery 20. In the present embodiment, the first connecting terminal 25a is a male connector and the second connecting terminal 20a is a female connector wherein the male connector 25a is inserted into the female connector 20a. In another embodiment of the disclosure, the first connecting terminal may be a female connector and the second connecting terminal may be a male connector. The washing device 100 may have an operation panel including a switch to turn the motor 10 ON and OFF.

In the present embodiment, the motor 10 and the battery 20 are disposed on the ground G via the base 31. In another embodiment, the motor 10 and the battery 20 may be disposed on the ground G with the base 31 omitted. The battery 20 may be disposed so that when viewed in a direction orthogonal to an axial direction of the shaft 15, the battery 20 and the motor 10 overlap with each other such as shown in FIG. 2. By disposing the battery 20 near or at a level of the motor 10, the center of gravity of the washing device 100 may be lowered closer to the ground G such that stability of the washing device 100 may be improved.

The motor 10 is disposed on the ground G or on the base 31 such that the shaft 15 of the motor 10 extends in a direction substantially orthogonal to a surface of the ground G. More specifically, the shaft 15 of the motor 10 extends vertically with respect to the ground G. When the washing device 100 includes the base 31, the shaft 15 of the motor 10 extends in a direction substantially orthogonal to a mounting surface of the base 30. The ground G may be, for example, a grass field, a floor in a building, a dirt ground, a concrete ground, a bottom of a cabinet and the like. The type of ground G is not intended to limit the disclosure. In more detail, a direction from the pump 40 towards the motor 10 is a direction of gravity. In other words, an extending direction of the shaft 15 is parallel to the direction of gravity.

The pump 40 is disposed on the motor 10 so that the motor 10 is disposed between the pump 40 and the ground G. The shaft 15 protrudes from the motor 10 to extend in a direction away from the ground G towards a first end. The first end of the shaft 15 is coupled to the pump 40. That is to say, the motor 10 is disposed between the shaft 15 and the ground G. In other words, the motor 10 is disposed below the pump 40 and on top the ground G so that the motor 10 is disposed between the pump 40 and the ground G. More specifically, when viewed in a direction orthogonal to an axial direction of the shaft 15, the motor 10 is disposed between the pump 40 and the ground G. In an embodiment where the base 31 is included in the washing device 100, the motor 10 and the pump 40 are disposed on the frame 31, and the frame 31 is disposed between the motor 10 and the ground G. By disposing the motor 10 under the pump 40, a center of gravity of the washing device 100 is lowered closer to the ground G such that stability of the washing device 100 may be improved. Furthermore, since the shaft 15 of the motor 10 extends upward directly towards the pump 40 that is disposed on the motor 10, a transmission distance of the rotation from the motor 10 to the pump 40 may be shortened.

The washing device 100 may include a bracket 32. The bracket 32 is configured to support the weight of the pump 40. In addition, the bracket may be configured to prevent relative rotation between the pump 40 and the motor 10 such that the shaft 15 rotates relative to the pump 40 to drive the pump 40. For example, one part of the bracket 32 may be fixed to the pump 40 while another part of the bracket 32 may be fixed to the motor 10 by, for example, fasteners. In another embodiment, one part of the bracket 32 may be fixed to the pump 40 while another part of the bracket 32 may be fixed to the base 31 by, for example, fasteners. A shape of the bracket 32 is not intended to limit the disclosure. The number of brackets 32 is not intended to limit the disclosure. The number of brackets 32 and a shape of the bracket 32 may be set according to requirements.

In the present embodiment, when the washing device 100 is viewed in the axial direction of the shaft 15, the pump 40 overlaps with the motor 10, and the pump 40 further overlaps with the shaft 15 of the motor 10. However, the disclosure is not limited thereto. In another embodiment of the disclosure, when the washing device 100 is viewed in the axial direction of the shaft 15, the pump 40 may not overlap with the motor 10, or may not overlap with the shaft 15 of the motor 10. However, the pump 40 is disposed on the motor 10 such that a first distance D1 between the ground G and a surface of the battery 20 closest to the ground G is smaller than a second distance D2 between the ground G and a surface of the pump 40 closest to the ground G. By disposing the battery 20 closer to the ground G, the center of gravity of the washing device 100 may be lowered closer to the ground G such that stability of the washing device 100 may be improved.

The pump 40 is driven by the motor 10. The pump 40 is driven by the motor 10 to pressurize a liquid. In the present embodiment, the liquid is water. However, the disclosure is not limited thereto. In another embodiment of the disclosure, the liquid may be, for example, soap water, a washing solution and the like. The type of liquid is not intended to limit the disclosure.

In the present embodiment, a rotation from the motor 10 is transmitted to the pump 40 via the shaft 15. That is to say, the rotation of the shaft 15 is coupled to the pump 40 to pressurize the liquid. In an embodiment of the disclosure, a gear may be coupled between the motor 10 and the pump 40 to vary the rotation per minute (RPM) received by the pump 40 according to requirements. The pump 40 may be, for example, a positive displacement pump or a centrifugal pump and the like. The workings of the pump 40 to pressurize a liquid may be understood by a person skilled in the art and will not be detailed here. The type of pump 40 is not intended to limit the disclosure.

The pump 40 includes a liquid inlet 40a and a liquid outlet 40b. The motor 10 is disposed between the liquid inlet 40a and the ground G, and the motor 10 is disposed between the liquid outlet 40b and the ground G. The liquid enters the pump 40 from the liquid inlet 40a and is pressurized by the pump 40. The liquid that entered the pump 40 is pressurized by the pump 40 and is then output from the outlet 40b of the pump 40. A pressure of the liquid that is output from the liquid outlet 40b is greater than a pressure of the liquid that is input from the liquid inlet 40a. In other words, a pressure of the liquid that is input from the liquid inlet 40a is smaller than a pressure of the liquid that is output from the liquid outlet 40b.

One end of a first hose (not shown) may be connected to the liquid inlet 40a and another end of the first hose may be connected to a water supply source such as a water faucet or the like. In addition, one end of a second hose (not shown) may be connected to the liquid outlet 40b and another end of the second hose may be connected to a water discharging device such as a nozzle gun (not shown). The nozzle gun may include a trigger to start and stop the ejection of pressurized water from the nozzle gun. In another embodiment of the disclosure, a water pipe may also be connected to the liquid inlet 40a and/or the liquid outlet 40b. By disposing the liquid inlet 40a and the liquid inlet 40b above the motor 10, it may be easier for a user to operate the washing device 100 such as when connecting or disconnecting the hoses to the liquid inlet 40a and/or the liquid outlet 40b.

Referring to FIG. 1, an opening of the inlet pipe 40a and an opening of the outlet pipe 40b face away from the shaft 15. However, the disclosure is not limited thereto, and the inlet pipe 40a and the outlet pipe 40b may be configured to face other directions and/or disposed on other surfaces of the pump 40 according to requirements.

The washing device 100 may include a plurality of wheels 70 attached to the frame 30. In the present embodiment, the plurality of wheels 70 are fixed to the base 31. However, the disclosure is not limited thereto and the plurality of wheels 70 may be attached to other portions of the washing device 100 instead of the base 31 according to requirements. A number of the wheels 70 is not intended to limit the disclosure. The wheel 70 may allow for easy transportation of the washing device 100, since the washing device 100 may be transported on the wheels 70.

In an embodiment of the disclosure, the base 31 may include stands (not shown) such that the wheels 70 may be elevated off the ground to prevent the washing device 100 from rolling on the wheels 70 during usage. The stands may also be used to level the washing device 100. The stands may include threads such that the stands may be fastened into the base 31 or out of the base 31 such that a protruding distance of the stands from the base 31 may be adjusted according to requirements. A number of the stands is not intended to limit the disclosure.

The washing device 100 may further include a hand bar 50 attached to the frame 30. In the present embodiment, the hand bar 50 is fixed to the base 31. However, the disclosure is not limited thereto and the hand bar 50 may be attached to other portions of the washing device 100 instead of the base 31 according to requirements. The hand bar 50 may be fixed to the washing device 100 by welding or a fastener and the like. The hand bar 50 allows for easy transportation of the washing device 100 by an operator, since the washing device 100 may be transported on the wheels 70 by pushing or pulling the hand bar 50.

In an embodiment of the disclosure, the battery 20 may include a plurality of batteries 20. That is to say, the washing device 100 may include a first battery 20 and a second battery 20 disposed electrically connected to the motor 10. By providing a plurality of batteries 20, a usage time of the washing device 100 may be extended. In addition, the plurality of batteries 20 may be connected in series or parallel according to power requirements, and/or according to the specification of the motor 10. A number of the plurality of batteries 20 are not intended to limit the disclosure and may be set according to requirements. The plurality of batteries 20 may be disposed at various location such as on the ground G and/or on the base 31.

It will be apparent to those skilled in the art that various modifications and variations can be made to the disclosed embodiments without departing from the scope or spirit of the disclosure. In view of the foregoing, it is intended that the disclosure covers modifications and variations provided that they fall within the scope of the following claims and their equivalents.

What is claimed is:

1. A washing device, comprising:
a motor, having a shaft;
a battery, electrically connected to the motor;
a pump, driven by the motor, the pump is adapted to pressurize a liquid;
wherein the pump is disposed on the motor so that the motor is disposed between the pump and a ground.

2. The washing device according to claim 1, wherein the shaft of the motor extends in a direction substantially orthogonal to a surface of the ground.

3. The washing device according to claim 2, wherein the pump includes a liquid inlet and a liquid outlet, and the motor is disposed between the liquid inlet and the ground, and the motor is disposed between the liquid outlet and the ground.

4. The washing device according to claim 3, wherein the battery is disposed so that when viewed in a direction orthogonal to an axial direction of the shaft, the battery and the motor overlap with each other.

5. The washing device according to claim 4, wherein a distance between the ground and a surface of the battery closest to the ground is smaller than a distance between the ground and a surface of the pump closest to the ground.

6. The washing device according to claim 5, wherein the battery is detachably attached to the washing device.

7. The washing device according to claim 6, wherein the battery is a rechargeable battery.

8. The washing device according to claim 7, further comprising a frame including a base, wherein the motor and the pump are disposed on the frame, and the frame is disposed between the motor and the ground.

9. The washing device according to claim 8, further comprising:
a wire, electrically connecting the battery to the motor; and
a wheel attached to the frame.
